(19) United States
(12) Patent Application Publication
(10) Pub. No.: US 2009/0184173 A1
(43) Pub. Date: Jul. 23, 2009

(54) ASSEMBLY COMPRISING A REFILL AND AN ASSOCIATED DETECTOR SYSTEM

(75) Inventor: Nicolas Duru, Paris (FR)

Correspondence Address: OLIFF & BERRIDGE, PLC, P.O. BOX 320850, ALEXANDRIA, VA, 22320-4850, US

(73) Assignee: L'OREAL, Paris (FR)

(21) Appl. No.: 12/298,103

(22) PCT Filed: Jul. 4, 2007
(86) PCT No.: PCT/IB07/52616

§ 371 Date: Feb. 9, 2009

Related U.S. Application Data
(60) Provisional application No. 60/833,804, filed on Jul. 28, 2006.

(30) Foreign Application Priority Data
Jul. 6, 2006 (FR) 06 52843

(51) Int. Cl. B05B 12/08; A45D 34/02

(52) U.S. Cl. 239/1; 239/74; 239/63; 239/602

(57) ABSTRACT

An assembly includes a refill containing at least one composition, and an appliance that is configured to receive the refill so as to extract the composition from the refill. The appliance also includes a detector system for detecting at least one portion in relief of the refill. The at least one portion in relief may be associated with at least one item of information, in particular information that is associated with the composition. The detector system may further include at least one switch having a membrane that can be actuated by at least one portion in relief of the refill.

The present invention relates to assemblies for dispensing or diffusing cosmetics or other compositions from at least one refill that contains at least one composition, and that is inserted in an appliance that is configured to receive it.

FR 2 795 348 describes a programmable appliance for diffusing fragrances, using refills that are optionally provided with portions in relief, the appliance thus optionally being equipped with means for automatically recognizing the refills used, by means of sensors that are integrated in the appliance.

There exists a need to transmit to the appliance, in simple and reliable manner, at least one item of information that is associated with at least one composition present in the refill, e.g. so as to be able to inform the user and/or to be able to adapt at least one dispensing or diffusing parameter to the composition.

Exemplary embodiments of the invention provide an assembly comprising:

a refill containing at least one composition; and

an appliance that is configured to receive the refill so as to extract the composition therefrom, said appliance including a detector system for detecting at least one portion in relief of the refill, said at least one portion in relief being associated with at least one item of information, for example information that is associated with the composition, the detector system comprising at least one switch having a membrane that can be actuated by at least one portion in relief of the refill.

The use of one or more membrane switches can facilitate making an appliance that is relatively flat and that is compact enough to be inserted in a pocket, for example.

In addition, in particular when the membrane is a membrane common to a plurality of switches, the membrane can isolate fairly easily one or more underlying electronic circuits from the environment outside the appliance, and that can turn out to be useful in the event of there being a risk of liquid splashes, for example, as can occur when the appliance is used in a bathroom.

The invention thus offers reliable, simple, and effective means for transmitting to the appliance in which the refill is placed, at least one item of information that is associated with at least one composition contained in the refill.

The detector system may comprise a plurality of membrane switches having a common membrane. This can facilitate obtaining a detector system that is leaktight and easy to manufacture.

The detector system may comprise a plurality of switches that are arranged in the form of a matrix.

The portions in relief may be arranged in a grid or otherwise, e.g. in a circle or a spiral.

The refill may include a plurality of portions in relief, and at least one item of information that is associated with the composition may be coded in matrix form by the portions in relief. The matrix may present any shape, being rectangular for example.

The refill may include a cylindrical body. At least a fraction of the portion(s) in relief of the refill may be disposed, at least in part, on the cylindrical body of the refill or at the end of said cylindrical body. The detector system may thus be arranged to detect the presence of portions in relief, if any, in angular sectors of the refill, about the axis of the body.

The number of portions in relief that might be present on a refill can depend on the quantity of information that is to be coded. In the limit, the refill could include only one portion in relief at a location that is fixed or that varies, in which event it is the location of the portion in relief on the refill that enables the information to be coded.

The portions in relief may be disposed is various ways, e.g. as a function of the shape of the refill.

The refill may include one or more projecting portions in relief and/or one or more hollow portions in relief, in particular in the form of holes that are optionally through holes. The hollow portions in relief make it possible to avoid actuating the corresponding switch(es) when the refill is in place.

The portion(s) in relief of the refill may be disposed on a single face of said refill. In a variant, the portion(s) in relief of the refill may be disposed on at least two faces of said refill.

When a plurality of refills are proposed containing different compositions, the refills may be made with portions in relief having different shapes that are associated with respective compositions, for example. This makes it easier to identify the refill visually and/or makes it possible to prevent a refill from being used in an appliance that is not provided for that purpose, with the appliance being arranged to detect the presence of portions in relief, if any, that have a certain shape only.

At least one of the portions in relief may be integrally molded with a wall of the refill, thereby making it easier to form said portion(s) in relief.

At least one of the portions in relief may also be formed by stamping or heat-deforming a wall of the refill.

At least one portion in relief may also be formed by piercing a wall of the refill, or even by an action of the user, e.g. by pulling off or cutting out a portion of the refill provided for this purpose.

In an embodiment of the invention, the wall carrying the portion(s) in relief may define, at least in part, a chamber of the refill containing a composition. In a variant, the portion(s) in relief may be formed on a wall of the refill that does not have that role.

The wall carrying the portion(s) in relief may optionally be deformed while the refill is being used in the appliance. Deforming the wall during use may be useful, e.g. so as to enable the appliance to detect a refill that has already been used. Thus, the appliance may be arranged firstly to deform at least one wall of the refill during use, and secondly to detect said deformation.

The refill may be made in various ways, e.g. as a function of the composition(s) that it contains and of the method of extraction. The refill may comprise a metal body, for example, which may be useful when extracting by injecting a hot fluid. In a variant, the refill may comprise a body made out of glass or out of other materials, e.g. a thermoplastic material.

At least one composition contained in the refill may be extracted in various ways.

Extraction may take place by injecting a fluid, for example. In a variant, extraction may be by removal, e.g. by pumping. The refill may also be provided with at least one wick in order to feed, by capillarity, a piezoelectric transducer for atomizing the composition, in particular for a perfume.

The refill may include a wall that is configured so as to make it possible to pass therethrough either an injector member for injecting an extraction fluid, or a member for pumping, or for removal by gravity.

Where appropriate, the refill may include a neck that can serve to dispense at least one composition contained in the refill and/or serve to insert an extraction fluid into at least one chamber of the refill.

The refill may also be equipped with a piston or with any other means that make it possible to dispense the composition by exerting pressure thereon.

The appliance may include a display system for displaying at least one item of information coming from the detector system. By way of example, the display system may be at least one indicator lamp, a screen, a display, e.g. a liquid crystal display (LCD) or an organic light-emitting diode (OLED) screen or the like.

The appliance may include an extractor system for extracting at least one composition contained in the refill, the extractor system possibly including an injector system for injecting at least one fluid into the refill. The extractor system may also include a piezoelectric transducer for atomizing the composition, or a pumping or piston-displacement system.

The refill may optionally be a single-use refill. The refill may include only one chamber. In a variant, the refill may include a plurality of chambers, and compositions contained in different chambers may be extracted simultaneously or in succession.

The portion(s) in relief may code an identifier of the refill, enabling the extractor appliance to recognize it, and for example memorize the state of the various chambers of the refill, where appropriate.

The refill may be associated with at least one item of authentication information, and the portion(s) in relief may code said information. For example, an item of information coded by the portion(s) in relief is compared with an item of information input by the user or coming from another source, and the operation of the extractor appliance may be possible only in the event of a match existing between said items of information.

In an embodiment of the invention, the portion(s) in relief of the refill project(s) by a relatively short distance that does not exceed 2 mm, for example. Nevertheless, such portions in relief can turn out to be sufficient for reading by means of one or more membrane switches.

Where appropriate, the refill may include polarizing means, but the portions in relief may perform that role, e.g. the appliance may be arranged not to operate if at least one portion in relief is not detected at a predefined location on the refill.

The refill may serve as packaging for various compositions.

In an embodiment of the invention, the refill contains at least one cosmetic. By way of example, the cosmetic may be a perfume, a hair care product, makeup for the skin, or a care product. It may also be a fragrance for creating a predefined atmosphere on being diffused in the ambient air.

The refill may include a single composition or a plurality of different compositions, the information coded by the portion(s) in relief of the refill making it possible to inform the appliance of the kind(s) of composition contained in the refill, for example.

The refill may include a single chamber containing the composition(s) to be extracted, the chamber being defined by a single capsule, for example. In a variant, the refill may include a plurality of capsules, containing different compositions to be taken or removed.

The information may be coded in binary manner. The information may do no more than reveal the presence or the absence of a refill in the appliance. The information may advantageously be coded using at least two bits, or even at least four bits, better at least eight bits, still better at least fourteen bits. At least one portion in relief may define a check bit making it possible to validate reading.

In another of its aspects, the invention provides a method of dispensing or diffusing a composition, the method comprising the step consisting in reading an item of information that is present on the refill by detecting the presence and/or the location of one or more portions in relief on the refill before diffusing or dispensing the composition.

The invention also provides a method of manufacturing a refill for an assembly as defined above, for example, in which a plurality of refills for containing different compositions are manufactured, initially with identical portions in relief, and in which method the portions in relief are modified during manufacture, as a function of at least one composition that is packaged in the refill. In this aspect of the invention, the portions in relief are detected by the appliance using any means, with one or more membrane switches or otherwise.

Independently or in combination with the above, the invention also provides a refill proper, regardless of the how the detector system is arranged, with one or more membrane switches or otherwise.

The invention can be better understood on reading the following detailed description of non-limiting embodiments thereof, and on examining the accompanying drawings, in which:

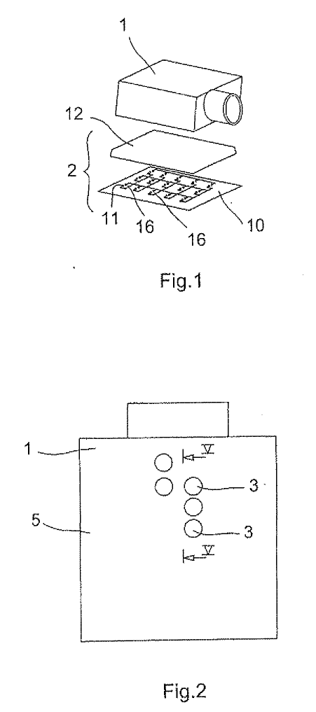

FIG. 1 is a fragmentary and diagrammatic exploded view in perspective of an example of a refill and of an associated detector system;

FIG. 2 is a view from below showing the FIG. 1 refill in isolation;

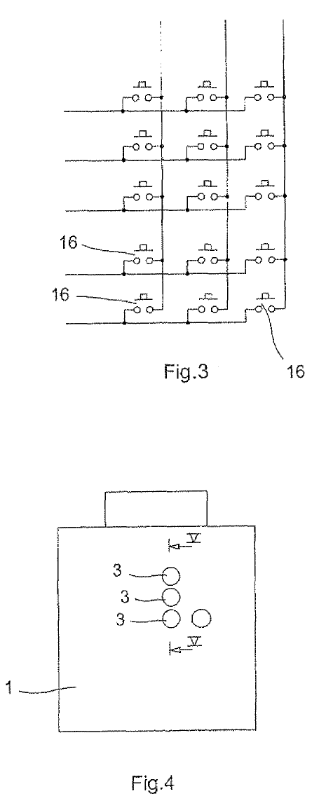

FIG. 3 is a diagram showing an arrangement of switches of the detector system;

FIG. 4 is a view similar to FIG. 2 showing a variation in the positioning of the portions in relief, corresponding to the coding of a different item of information;

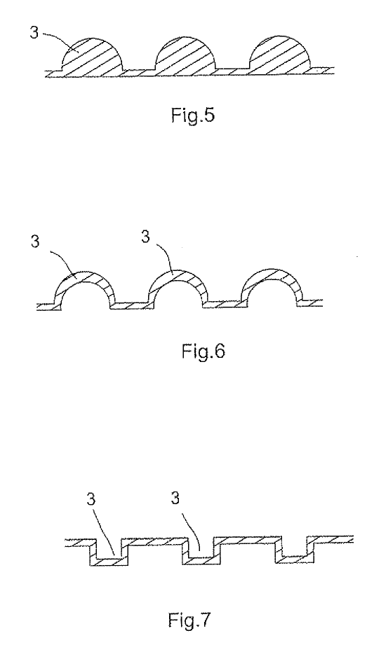

FIG. 5 is a cross-section on V-V in FIG. 2;

FIGS. 6 and 7 are views similar to FIG. 5 showing variant embodiments of the portions in relief;

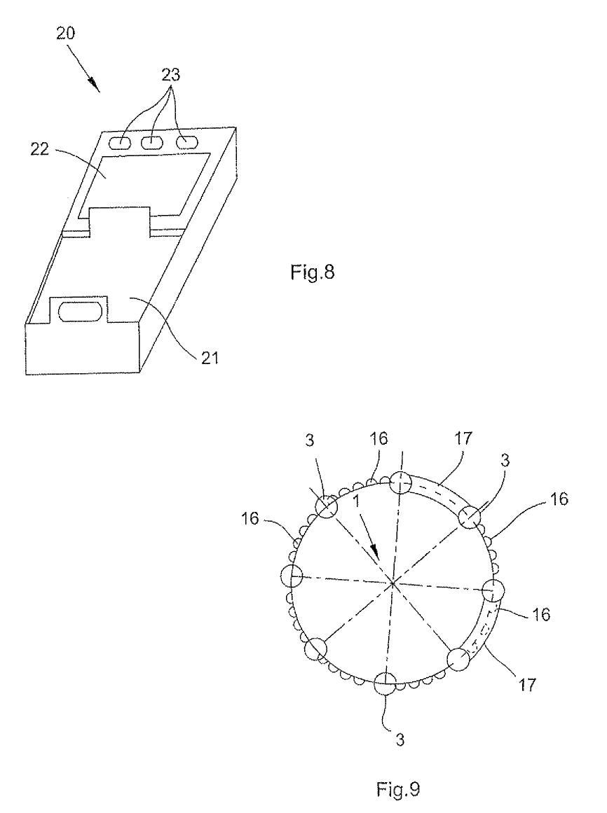

FIG. 8 is a diagram showing, in isolation, a reader system for reading the refill;

FIGS. 9 to 11 show other examples of arrangements for the portions in relief on the refill, FIG. 9 also indicating the corresponding positioning of the switches 16; and

FIG. 12 shows another example of a refill, including a plurality of chambers.

FIG. 1 is a diagram showing a refill 1 and an associated detector system 2 that makes it possible to detect the presence or absence, on the refill 1, of portions in relief that code an item of information relating to at least one composition contained in the refill.

By way of example, the item of information can be the name of the composition, its batch number, a use-by date, a place of manufacture, etc. and/or at least one item of information that is useful while the refill is being used in an extractor appliance for extracting at least one composition contained in said refill, e.g. at least one item of information that is associated with an appliance operating parameter that depends on the composition.

The detector system 2 can form part of the extractor appliance, e.g. being present, at least in part, in a housing for receiving the refill.

In the embodiment shown, the refill 1 is in the form of a receptacle that is provided with a neck, but, in variants, it could be made in some other way, e.g. in the form of a bag or a flexible pouch, or any other receptacle that does not have a neck.

The extractor appliance can be an appliance that extracts by atomizing by means of a piezoelectric transducer, or an appliance that extracts by injecting a fluid into the refill, or even an extractor appliance that is arranged to remove at least one composition contained in the refill by suction, or in some other way, e.g. by displacing a piston.

For atomizing the composition, the refill can include a wick that makes it possible to feed the piezoelectric transducer by capillarity. The wick can extend into the neck of the receptacle, for example.

When the extractor appliance is arranged to extract composition by injecting a fluid, the fluid can be hot water, a mixture of water and steam, or steam only, for example.

In accordance with the invention, the refill 1 carries at least one item of information that is coded by means of portions in relief.

By way of example and as shown in FIG. 2, the portions in relief are in the form of bumps 3 that are disposed on a face 5 of the refill 1, and that come to cooperate with the detector system 2.

For example, when the refill 1 is placed in the extractor appliance, the portions in relief 3 are detected, in such a manner as to enable said extractor appliance to receive an item of information relating to its operation given the compositions that are present in the refill, for example, and/or to inform the user of the kind of compositions contained in the refill.

The detector system 2 can include various sensors that make it possible to detect the presence or absence of a particular portion in relief at a given location on the refill.

In the embodiment under consideration, the detector system 2 includes a plurality of switches 16 that are disposed in a matrix arrangement, as shown in FIG. 3. By way of example, the switches 16 are formed by a printed circuit 10 that presents electrical contacts 11, possibly made of carbon, with a flexible membrane 12 placed facing them, which membrane presents, at least locally, conductive portions that are pressed by the portions in relief 3 against the contacts 11 in order to close the corresponding switches. The printed circuit 10 and the membrane 12 are similar to those found in flexible keypads, for example. The membrane 12 need not even present conductive portions, which can be interposed between the printed circuit and the membrane, for example.

Where appropriate, the printed circuit 10 can carry, on one face, contacts or components that make it possible to detect the presence of portions in relief, and, on the opposite face, components that make it possible to process the information detected in this way.

In addition, if the surface of the refill 1 carrying the portions in relief 3 is not plane, the use of a flexible printed circuit makes it possible to detect portions in relief by substantially matching the shape of the surface.

The information that is associated with the portions in relief 3 of the refill 1 can be coded using a binary code, the presence or absence of a portion in relief at a predetermined location on the refill corresponding to a 0 or 1 state in a binary sequence.

FIG. 4 shows a different code formed on the FIG. 1 refill, some of the portions in relief that are present in FIG. 2 being absent, and others being present.

In the embodiment under consideration, the information is coded using 15 bits, but it could be coded using a greater or smaller number of bits, e.g. as a function of the quantity of information to be transmitted to the extractor appliance and/or to the user.

Where appropriate, part of the information can also be coded in non-binary manner, the detector system being arranged to detect an intermediate state between two extreme states 0 and 1.

The information coded by the portions in relief can optionally be present elsewhere on the packaging of the refill, or on associated instructions in a form that can optionally be understood directly by the user.

The portions in relief 3 can be formed in various ways on the refill, e.g. being made integrally with the body of said refill by molding, as shown in FIG. 5.

In this figure, it can be seen that the portions in relief can be formed by a local increase in thickness of material.

The portions in relief can also be made other than by increasing thickness, e.g. by molding or stamping, as shown in FIGS. 6 and 7.

The portions in relief can also be formed by machining, in particular by cutting-out, by drilling, or by milling, or even by burning the material of a wall of the refill, or by heat-deforming said wall.

The portions in relief can be made in various shapes, e.g. they can present a bump shape with a rounded profile, in particular an outwardly-convex profile, as shown in FIG. 5, or they can present a hollow shape, as shown in FIG. 7.

The shape of the portions in relief is selected as a function of the kind of switches or other possible sensors of the detector system. For portions in relief that are hollow, for example, said portions in relief, when present, do not press on the corresponding switches of the detector system.

The portions in relief can be made in specific manner, as a function of the composition(s) contained in the refill.

A plurality of refills having different portions in relief can be manufactured separately, and the refills can then be filled with the composition(s) corresponding to the information coded by the portions in relief. Where appropriate, the line that fills and packages the refills can make use of a reader for reading the portion(s) in relief carried by said refills.

Initially, the refills can all be manufactured with the same portions in relief, e.g. using the same mold, and some of the portions in relief can then be modified as a function of the composition(s) filling the refill, resulting in the refills being different.

The portions in relief of the refill can be read by the extractor appliance itself, when the refill is in a configuration that makes it possible to extract the composition(s) contained therein. In a variant, the portions in relief can be read when the refill is not in a configuration that makes it possible to extract the composition(s) contained therein.

For example, prior to the refill being put into place in the housing that is used for extraction, the refill is placed in a special housing for reading the portion(s) in relief coding the information.

The special housing can be formed in the extractor appliance itself, or, in a variant, in a reader device 20 that is separate from the extractor appliance, as shown in FIG. 8.

The reader device 20 includes a casing presenting a housing 21 in which the refill is disposed, so as to make it possible to read the portion(s) in relief. The reader device 20 comprises an electronic circuit that is associated with a detector system for detecting the portions in relief, so as to cause at least one item of information coming from the detector system to be displayed on a display 22.

The reader device 20 can optionally be configured to write information on the refill, e.g. by modifying a portion in relief.

The reader device 20 can include a user interface 23 comprising one or more keys on which the user can press so as to select an operating parameter, for example.

Where appropriate, the information detected by the reader device 20 can be combined with at least one other item of information, the other item of information being, for example, an item of information input by the user and/or coming from at least one sensor, e.g. the user's hair or skin color.

The information that is coded on the refill makes it possible to inform the extractor appliance of the kind of composition(s) contained in the refill.

The extractor appliance can include a display system for displaying the information resulting from detecting the portion(s) in relief of the refill, so as to inform the user before extraction begins. By way of example, the display system could display the name and/or a characteristic of the composition.

By way of example, the extractor appliance can be arranged in such a manner as to begin extraction only in response to a confirmation instruction on the part of the user, following the above-mentioned display.

The extractor appliance can present various forms, as can the refill and the portions in relief that are formed thereon.

The portions in relief 3 can be disposed about a longitudinal axis of the refill, in particular when said refill presents a cylindrical body. In this event, the switches 16 can be disposed in a circle, and the information can be coded in the form of individual portions in relief 3 that each press locally and simultaneously on a single switch 16, or sectors 17 that extend to a greater or lesser extent and that come to press simultaneously on a plurality of switches 16, as shown in FIG. 9.

The switches 16 can be disposed over a complete circumference. Where appropriate, this makes it possible to read the information carried by the portions in relief regardless of the orientation of the refill relative to the detector system.

The portions in relief could also be disposed in a line along a generator line of the refill, in a variant not shown.

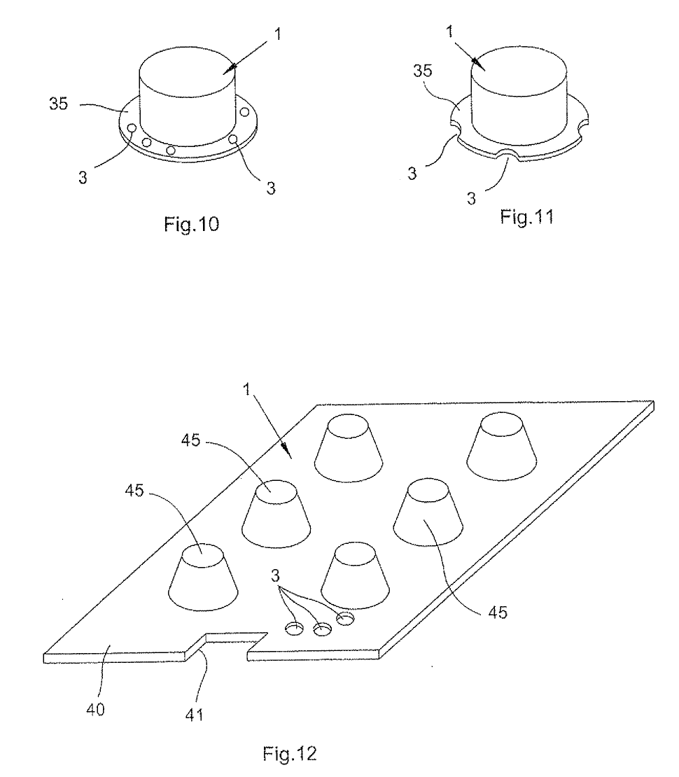

The portion(s) in relief can be made in some other way, e.g. in the form of holes that can be made in a collar 35 of the refill, as shown in FIG. 10, or in the form of notches formed in the periphery of such a collar 35, as shown in FIG. 11.

The refill can include a single chamber containing a single composition, or, in a variant, a plurality of chambers defined by at least two compartments, each containing a respective composition.

The refill can also include a plurality of separate chambers, as shown in FIG. 12. By way of example, the chambers are in the form of capsules 45 that are secured to a support 40 that is in the form of a plate for example. By way of example, the portions in relief are formed on the support 40, and they can code an item of information relating to at least one of the compositions present on the refill. Where appropriate, the refill can also include a portion in relief that forms polarizing means 41.

By way of example, the FIG. 12 refill is for using with an extractor appliance that includes a plurality of injectors that are associated respectively with different capsules 45.

The information that is coded on the refill can also be an identifier that enables the extractor appliance to recognize the refill, and, by means of an internal memory, to know which chambers have already been used.

The invention is not limited to the embodiments described above. In particular, the characteristics of the various embodiments could be combined together within variants not shown.

Where appropriate, the extractor appliance could be arranged to act on at least one portion in relief while the refill is being used, in such a manner as to prevent the refill from being used again subsequently.

By way of example, after extraction, one of the portions in relief could be deformed by the extractor appliance, and such deformation could then be detected by the extractor appliance in the event of an attempt being made to reuse the refill. By way of example, this makes it possible to prevent a user from attempting to reuse the refill after said refill has already been used once.

The composition(s) contained in the refill could be various, e.g. being perfumes, hair dyes, or makeup for the skin, the lips, hair, or the nails.

The invention could also apply to compositions other than cosmetic or pharmaceutical compositions, e.g. foodstuffs or household cleaning products.

The expression “comprising a” should be understood as being synonymous with “comprising at least one”.

1. An assembly comprising:
a refill containing at least one composition; and
an appliance that is configured to receive the refill so as to extract the composition therefrom, said appliance including a detector system for detecting at least one portion in relief of the refill, the at least one portion in relief being associated with at least one item of information, the detector system comprising at least one switch having a membrane that can be actuated by at least one portion in relief of the refill.

2. An assembly according to claim 1, wherein said at least one item of information is associated with the composition.

3. An assembly according to claim 1, the detector system comprising a plurality of membrane switches having a common membrane.

4. An assembly according to claim 1, the detector system comprising a plurality of switches arranged in the form of a matrix.

5. An assembly according to claim 1, the refill including a plurality of portions in relief, at least one item of information that is associated with the composition being coded in matrix form by the portions in relief.

6. An assembly according to claim 1, the refill including one or more projecting portions in relief.

7. An assembly according to claim 1, the refill including one or more hollow portions in relief.

8. An assembly according to claim 1, at least a fraction of the portion(s) in relief of the refill being disposed on a single face of said refill.

9. An assembly according to claim 1, at least a fraction of the portion(s) in relief of the refill being disposed, at least in part, on a cylindrical body of the refill or at one end of said cylindrical body.

10. An assembly according to claim 1, at least one portion in relief being integrally molded with a wall of the refill.

11. An assembly according to claim 1, at least one portion in relief being formed by stamping or heat-deforming a wall of the refill.

12. An assembly according to at least one portion in relief being formed by piercing a wall of the refill.

13. An assembly according to claim 10, the wall defining, at least in part, a chamber of the refill containing the composition.

14. An assembly according to claim 1, the appliance including a display system for displaying at least one item of information coming from the detector system.

15. An assembly according to claim 1, the appliance being arranged to atomize the composition contained in the refill.

16. An assembly according to claim 1, the refill being a single-use refill.

17. An assembly according to claim 1, the portion(s) in relief of the refill projecting by a distance that does not exceed 2 mm.

18. An assembly according to claim 1, the refill including polarizing means.

19. An assembly according to claim 1, the refill including a cosmetic.

20. An assembly according to claim 1, the refill including a plurality of different compositions.

21. An assembly according to claim 1, the detector system being arranged to detect the presence of portions in relief, if any, in angular sectors of the refill, about its axis.

22. An assembly according to claim 1, the information coded by the portion(s) in relief of the refill making it possible to inform the appliance of the kind(s) of composition contained in the refill.

23. An assembly according to claim 1, the information being coded in binary manner.

24. An assembly according to claim 23, the information being coded using at least four bits.

25. An assembly according to claim 24, the information being coded using at least four bits, better at least eight bits.

26. An assembly according to claim 25, the information being coded using at least four bits still better at least fourteen bits.

27. An assembly according to claim 1, including at least two refills containing different compositions and having portions in relief of different shapes, the shapes being associated with respective compositions.

28. A method of dispensing or diffusing a composition, the method comprising reading an item of information that is present on a refill as defined in claim 1, by detecting the presence and/or the location of one or more portions in relief on said refill before dispensing or diffusing the composition.

29. A method of manufacturing a refill for an assembly as defined in claim 1, in which a plurality of refills for containing different compositions are manufactured, initially with identical portions in relief, and in which the portions in relief are modified during manufacture, as a function of at least one composition that is packaged in the refill.
